(19) United States
(12) Patent Application Publication
(10) Pub. No.: US 2011/0239620 A1
(43) Pub. Date: Oct. 6, 2011

(54) METHOD FOR PROCESSING ORGANIC WASTE AND A DEVICE FOR CARRYING OUT SAID METHOD

(76) Inventor: Sergey Vasiljevich Pashkin, Moscow (RU)

(21) Appl. No.: 12/998,824

(22) PCT Filed: Dec. 28, 2009
(86) PCT No.: PCT/RU2009/000730

§ 371 Date: Jun. 7, 2011

(30) Foreign Application Priority Data
Dec. 29, 2008 (RU) 2008152111

(51) Int. Cl. F02C 3/28; C10B 57/04; C10B 1/00

(52) U.S. Cl. 60/39.12; 201/2.5; 202/84

(57) ABSTRACT

The invention relates to alternative power engineering, more specifically to methods and devices for processing organic waste into thermal and electrical energy, liquid, solid and gaseous energy carriers and into other useful chemical products. The method differs from a known method for the pyrolysis processing of organic waste through air-free thermal heating in that the thermal heating is carried out in an aqueous medium at pressures in the medium that are greater than the pressure of saturated water vapor at the highest pyrolysis temperature. As a result, humid and liquid organic waste can be processed into combustible energy carriers without pre-drying, and the heat energy produced when the pyrolysis products are burned can be used both for maintaining the organic waste processing process and for producing commercial heat and electrical energy.

### CROSS-REFERENCE TO RELATED APPLICATIONS

This application is a U.S. national stage application of a PCT application PCT/RU2009/000730 filed on 28 Dec. 2009, whose disclosure is incorporated herein in its entirety by reference, which PCT application claims priority of a Russian Federation application RU2008152111 filed on 29 Dec. 2008.

### FIELD OF THE INVENTION

The invention relates to the field of power engineering, and more specifically, to alternative independent sources for generating heat and electricity, liquid, solid and gaseous energy carriers, as well as obtaining useful chemical products during the pyrolysis treatment of municipal, agricultural and industrial organic wastes, particularly: wood, leaves, manure and manure runoff, bird droppings, peat, rotting straw, rubber and plastic chips, black liquor, sewage sludge, liquid waste food, brewing and alcohol industry wastes, and other types of liquid and solid organic wastes.

### BACKGROUND OF THE INVENTION

Widely known are methods of producing heat and electricity, fuels, and chemicals by thermal processing of organic waste. The simplest way to generate energy from waste is burning thereof in the kilns, furnaces, and other devices to produce heat and steam, where steam can then be used in steam engines to generate electricity.

Another way for obtaining energy, and energy carriers is the gasification of organic waste, in particular, wood chocks in gasification facilities, is the process of thermal decomposition of the waste under high temperatures (up to 1100 C) in the process of burning the same waste with limited access of air. Obtained in these devices producer gas can be used not only as a boiler fuel, but also as fuel for internal combustion engines and is the raw material for production of synthetic liquid and gaseous fuels (see, e.g. RU 2303192 C1). Because of the presence of combustion and nitrogen products in the generator gas, the gas generator has a low calorific value and limited usability for application in the synthesis of motor fuels.

The gas-producing facilities typically have a low energy performance, which is additionally complicated by large dimensions of equipment for drying of lumpy material. This is a consequence of the low efficiency of heat transfer from the hot gas to the raw materials being processed due to a low thermal conductivity of the gas and raw materials, an inability to quickly raise the temperature to 350 or more degrees Celsius inside the lump raw material for gasification thereof until the water contained in this raw material evaporates. Due to the heterogeneity of material composition, humidity, size of pieces, as well as a long time of transition of the output units into the operating mode, this technology is difficult to automate.

These drawbacks are eliminated in the pyrolysis technology of waste processing, conducted at 400-900 C without air access. Pyrolysis products have a high calorific value, a wide range in composition of derived hydrocarbons, and are of greatest interest for use directly in power-production facilities, or for further chemical processing into motor fuels.

A known method for processing of organic materials by pyrolysis, protected by a Russian Federation Patent RU2260615 involves a rapid pyrolysis in a stream of preliminary prepared raw material (crushed to a size of about a millimeter and dried) at temperatures of 450-800 C depending on the chosen technology for obtaining the final product. Thermal energy is transmitted to the raw material through its contact with rolling working bodies—bils being preheated and having a high thermal conductivity. An efficient contact heat transfer from the solid heated bils to the dried shredded raw material ensures a rapid heating and gasification of the entire mass being processed. The possibility of continuous operation of the plant, described in Patent RU2260615 provides for a good performance, efficiency, and reliability thereof. A high degree of automation enables a reliable control of parameters set in the process. The pyrolysis products are used directly for generation of heat and electricity, and for conversion thereof into liquid, solid, and gaseous fuels with desired properties.

However, this pyrolysis technology, as well as the above-mentioned gas-based technologies and the technology for direct combustion of waste, require pre-drying the waste (for pyrolysis of waste, the moisture content should not exceed usually 10%, and for gas-generating plants and facilities in direct incineration it should not exceed 30-50%), which consumes a considerable amount of energy, and requires special drying devices. Fumes and gases evolved during the drying stage, can pollute the environment, especially if the waste contains mercury, lead, zinc, sulfur, dioxins, benzopyrene and other impurities (leaves in the city, industrial waste, etc.). Pyrolysis of the above-mentioned technologies applied to some wastes, such as liquid effluents livestock farms, fresh bird droppings, waste from food production, sewage sludge, black liquor, etc., with a humidity in the range of 90-99%, is too costly, and environmentally and economically unviable (more details on the economic and technical aspects of the issue see, for example: “Biomass and Bioenergy wood. Monograph”/D. A Zanegin, I. V. Voskoboinikov, V. A. Kondratyuk, V. M. Shchelokov—Moscow, 2008.—Vol. 1—428 p.—Vol. 2—456 p).

### BRIEF DESCRIPTION OF THE INVENTION

The primary aim of this invention is to eliminate the above described drawbacks of known methods and devices, thereby increasing the economic and environmental performance of pyrolysis technology for processing wet and liquid organic wastes.

The aforesaid aim is achieved by an inventive method for processing and recycling organic waste. In a preferred embodiment, the method includes: grinding the waste; gasification of the ground waste in a thermochemical reactor by pyrolysis; and supplying the gaseous pyrolysis products into a combustion chamber of a power-conversion installation or/and into an installation for chemical conversion of pyrolysis products into synthetic fuels; wherein the method is characterized in that: water is added in the crushed (ground) mass of waste and mixed therewith forming pulp, so that the concentration of water in the pulp is provided in the range of 30-99%; then the pulp is fed by a high pressure pump or a piston into the termochemical reactor, providing the pressure of the pulp is higher than the saturated vapor pressure of water over the entire range of operating temperatures of the thermochemical reactor; the pulp is heated in the thermochemical reactor to a temperature at which the pyrolysis of organic waste is occurred, which pyrolysis is performed through air-free thermal heating carried out in an aqueous medium, and entails formation of low molecular weight compounds (CO, CO2, H2, CH4, methanol, dimethyl ether, etc.); wherein the pyrolysis process results in obtaining pyrolysis products including a solid fraction, a liquid fraction, and a gaseous fractions; wherein the gaseous fraction includes: flammable gases, vapors, and volatile liquids; wherein the solid fraction of the pyrolysis products is extracted; the pyrolysis products with water are cooled and their pressure is reduced by conventional ways, including by performing a useful mechanical work; the gaseous fraction is separated from the liquid fraction; the gaseous fraction is directed into the combustion chamber or/and to the installation for chemical conversion of pyrolysis products into synthetic fuels; useful products (e.g., acetic acid, salt, etc,) are extracted from the liquid fraction, resulting in that the liquid fraction mostly including water; and then the so obtained water returns to the production cycle, being added to the crushed (ground) waste.

In general, the inventive method for processing and recycling organic waste employs at least: a thermochemical reactor providing a pyrolysis processing of aforesaid organic waste through air-free thermal heating carried out in an aqueous medium, wherein the pyrolysis processing is characterized with a predetermined operating temperature range; a power-conversion installation with a combustion chamber, and/or an installation for chemical conversion of pyrolysis products into synthetic fuels; wherein the method comprises the steps of: (a) grinding the waste thereby forming a ground waste mass; (b) adding water into the ground waste mass thereby forming a mixture; (c) agitating the mixture thereby forming pulp, so that a concentration of water in aforesaid pulp is kept within a range of 30-99%; (d) feeding the pulp into the thermochemical reactor, so that a pressure of the pulp is kept greater than the pressure of saturated water vapor over the entire aforesaid predetermined operating temperature range; (e) heating the pulp in the thermochemical reactor up to a predetermined temperature at which the pyrolysis processing takes place, thereby forming the pyrolysis products with formation of low molecular weight compounds, wherein aforesaid pyrolysis products include: a solid fraction, a gaseous fraction, and a liquid fraction including at least water and predetermined substances, wherein each aforesaid fraction has a corresponding pressure; (f) extracting the solid fraction from the pulp; (g) cooling the liquid and gaseous fractions; (h) reducing the pressure of aforesaid liquid and gaseous fractions by conventional ways, including by performing a mechanical work; (i) separating the gaseous fraction from the liquid fraction; (j) transferring the gaseous fraction into the combustion chamber, and/or into the installation for chemical conversion of pyrolysis products into synthetic fuels; (k) extracting the predetermined substances from the liquid fraction, causing the liquid fraction to mostly include water; and (l) returning the so obtained water of aforesaid liquid fraction into the ground waste mass, according to the step (b).

An additional distinct feature of the inventive method is that the pressure of the pulp in the thermochemical reactor is established within the range of 22.0-40.0 MPa, whereas a maximum temperature in the thermochemical reactor is raised up to 350-900 C, and the pulp is exposed at these parameters within a time range of 0.1-10 minutes.

Another distinct feature of the inventive method is that the heating of the pulp and the cooling of water containing pyrolysis products are provided by heat exchange between the pulp and the water containing the pyrolysis products arranged in a recuperative heat exchanger, wherein the flow of water containing the pyrolysis products (or the flow of the liquid fraction) and the flow of pulp, entering the recuperative heat exchanger, move in opposite directions, and heat energy to offset heat losses is induced into the flow of pulp in an additional heat exchanger connected to a predetermined hot part of the recuperative heat exchanger, for example, taking the heat from the exhaust gases escaping the combustion chamber of the power-conversion installation.

Another distinct feature of the inventive method is that the evolution of non-condensable gases (H2, CO, CH4) from the pyrolysis products is provided from the pulp flow at temperatures below 370 C, regardless of the pressure; and the evolution of volatile liquids (ethanol, methanol, dimethyl ether, etc.) is provided at a temperature below 240 C and a pressure below 10 MPa at a condition when a predetermined substantial portion of water is being in the condensed state, while reducing the pressure of gaseous pyrolysis products is provided by throttling or a completion of mechanical work in an expansion refrigerator. Since the combustible components have a pressure and a temperature respectively higher than the normal pressure and temperature, this enables conducting the synthesis reaction of hydrocarbons in the presence of catalysts in optimal conditions and transferring the fuel from the thermochemical reactor into the combustion chamber of a gas turbine or a diesel engine without the use of a booster compressor.

Another distinct feature of the inventive method is that during formation of the pulp, the method envisages adding special additives into water, for example, such as sodium hydroxide or sodium sulfate. The additives accelerate the process of pyrolysis—by lowering the activation energy of chemical reactions, and—due to the dissolution and homogenization of certain types of solid waste. The additives of this type are widely used, particularly in the paper industry for pulping.

There is also disclosed herein an inventive device for implementing the proposed method, wherein the aforesaid aim is achieved due to a special design of the inventive device as follows below.

The inventive device for processing organic wastes comprises: a grinder of waste; a thermochemical reactor for pyrolysis of waste; a power-conversion installation; a reactor for synthesis of fuels from pyrolysis gases, the reactor for synthesis of fuels includes a fraction divider (e.g. a rectification column) for separation of the fuels; a bunker with a mixer (agitator) to prepare the pulp from a mixture of ground organic waste with water, a pump or piston to create a pressure in the pulp flow passing through the thermochemical reactor; an ash collector for receiving and removing components of the solid fraction (mainly, ashes, i.e. refuse burnout) of pyrolysis products; a pyrolysis gas separator to separate the gas fraction from the liquid fraction.

Another distinct feature of the inventive device is the use of a recuperative heat exchanger of the spiral type and an additional heat exchanger heating the pulp from an external heat source; wherein the recuperative heat exchanger receives the flow of the pulp from the pump; the additional heat exchanger receives the flow of the pulp from the recuperative heat exchanger, the additional heat exchanger has an outlet of the pulp, and the ash collector is mounted at the outlet receiving the components of the solid fraction. The recuperative heat exchanger and the additional heat exchanger are used for heating up the pulp to an operating temperature in the thermochemical reactor.

Another distinct feature of the inventive device is that the thermochemical reactor has an output of products of thermochemical reactions from the pyrolysis zone, wherein the pyrolysis process takes place; and the inventive device comprises an expansion refrigerator, mounted at the aforesaid output of products, and used for utilization of the potential energy of compression of the pyrolysis products.

Another distinct feature of the inventive device is that the power-conversion installation (without a booster compressor) is represented by one of the following: an internal combustion engine, a diesel engine, a gas turbine engine, a steam engine, a Stirling engine, or the like with an electric generator and a unit for utilization of the heat of exhaust gases.

### BRIEF DESCRIPTION OF DRAWINGS

The essence of the invention is illustrated in FIG. 1 and FIG. 2.

FIG. shows a simplified flow chart of processing of organic waste according to the proposed method.

FIG. 2 shows a simplified diagram of the thermochemical reactor.

### DESCRIPTION OF PREFERRED EMBODIMENTS OF THE INVENTION

While the invention may be susceptible to embodiment in different forms, there are described in detail herein below, specific embodiments of the present invention, with the understanding that the present disclosure is to be considered an exemplification of the principles of the invention, and is not intended to limit the invention to that as illustrated and described herein.

According to a preferred embodiment, a device for implementing the inventive technological method for processing of organic waste is schematically presented in FIG. 1. The inventive device comprises: a grinder 1 of organic waste; a bunker 2 with a mixer (not shown) for preparing the pulp, the bunker 2 is connected to the grinder 1; a high-pressure pump 3 to create a flow of the prepared pulp; a thermochemical reactor 4 connected to and receiving the pulp flow from the pump 3, wherein the pyrolysis of waste and the ash removal from the pulp flow are conducted; an optional reactor 5 for synthesis of fuels, connected to the thermochemical reactor 4, the synthesis reactor 5 has an outlet for output of hydrocarbons to the fraction divider (not shown, being part of the reactor for synthesis of fuels 5); an engine 6 together with an electric generator 7 for generating electric energy, wherein the engine 6 has a cooling system, wherein the engine 6 and the generator 7 collectively form a power-conversion installation, and wherein the engine 6 includes a combustion chamber; a heat recovery unit 8 for utilizing—the heat energy of water coming out of the thermochemical reactor 4, and—the heat energy of the residual products of pyrolysis dissolved in water; a heat recovery unit 9 for utilizing the waste heat from the engine's cooling system.

FIG. 1 does not indicate a device for utilization of thermal energy of exhaust gases of the engine and the expansion refrigerator for recovery of compression energy of the pyrolysis products.

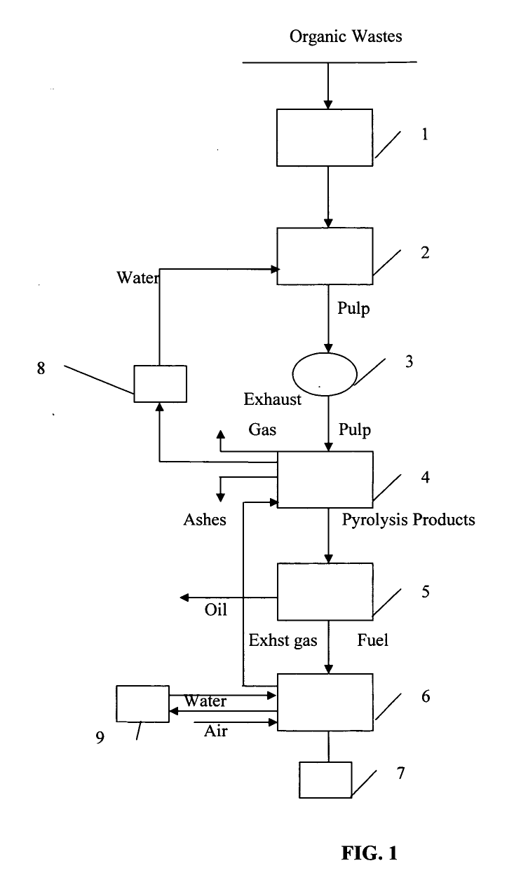

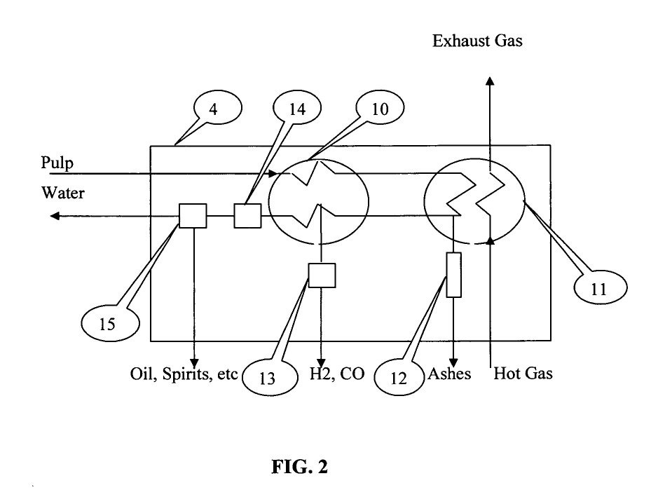

The thermochemical reactor 4 (see FIG. 2) includes a recuperative heat exchanger 10 for preheating the pulp and cooling the pyrolysis products off; and an additional heat exchanger 11 (having a primary and a secondary circuits of heat exchange) for heating up the pulp and to obtain a preset temperature of the pyrolytic process in the thermochemical reactor. The thermochemical reactor 4 is equipped with an ash collector 12 for collecting and removing the ashes and other components of the solid fraction, a separator 13 of light gases, a pressure reduction unit 14, and a separator 15 of vapors of volatile liquids.

The inventive technology for processing organic waste works as follows. Organic waste (such as sawdust, fallen leaves, peat moss, liquid manure runoff, bird droppings, alcohol stillage, etc.), including a solid fraction thereof, is introduced into the grinder 1, wherein the size of the solid fraction particles is predeterminedly reduced so that they do not get stuck in the high-pressure pump 3 and in the hydrodynamic tract. In preferred embodiments, their size should not exceed a few millimeters. Restrictions on the size of the particles associated with the conventional pyrolytic process here is much less important, since:—firstly, the proposed technology does not involve the evaporation of water from the waste, which deduces heat energy from the energy source, and—secondly, the heat transfer from the heated water to the wastes is much more efficient, than the heat transfer from the heated gas (about two orders of magnitude).

The waste, being ground and separated, is delivered from the grinder 1 into the bunker 2 for preparation of the pulp. Water, preferably recycled from the thermochemical reactor 4 (via the heat recovery unit 8, as shown in FIG. 1), is also introduced into the bunker 2.

Most of the wastes of biological origin have a humidity of more than 50% (e.g., the moisture of wood content is about 50%, the moisture of litter and manure runoff content ranges from 80 to 95%). The excess water flowing into the bunker from the thermochemical reactor 4, is discharged into the sewer or used for other purposes. The minimum moisture content of the prepared pulp is determined by the expenditure capacity of the pump and the hydrodynamic conduit for pumping thereof. For some types of waste (coal, rubber chips, etc.), the minimum humidity can reach 30-40%, whereas, for the majority of wastes of biological origin, the minimum humidity is typically 80-90%.

The homogeneity of the pulp is provided with a conventional mechanical agitator (not shown in FIG. 1). The agitator can also “wash” the waste from adhering dirt, sand, etc., which sinks to the bottom of the bunker (due to its greater density) and is periodically removed.

Through the high-pressure pump 3, (which is usually a pump of the membrane type, though a hydraulic press can be used instead as well), the prepared pulp is fed into the thermochemical reactor 4.

In the thermochemical reactor 4 (see FIG. 2), the flow of pulp enters the recuperative heat exchanger 10, while moving in a forward direction, and its temperature is rising steadily due to the heat exchange with the flow of water containing the pyrolysis products (i.e. the liquid fraction) moving in the opposite direction. The temperature of the liquid fraction pyrolysis products can reach 350-900 C. It is therefore important that the pressure of pulp be always greater than the saturated water vapor pressure, which constitutes a novel feature of the present invention. In this case, a heat-exchange crisis can be avoided. Such crisis otherwise could have arisen out of ‘steam pads’, which would have dramatically reduced the efficiency of heat transfer, and in some cases would have lead to the destruction of the heat exchanger.

On the other hand, the aforesaid measure can help avoiding scale deposits on the walls of the heat exchanger, which also affect the efficiency of heat transfer and the lifespan of the heat exchanger. A phase transition of water from the liquid to the gaseous state in the proposed technology does not occur, due to the absence of the ‘steam pads’ that is due to the lack of water evaporation, which consumes large energy.

A pyrolysis process of certain wastes (peat, wood, etc.) is accompanied by certain temperature exothermic processes, i.e., occurs with the release of energy, but it's usually not enough to bring the technological process of pyrolysis to a necessary temperature mode. Therefore, the additional high-temperature heat exchanger 11 is installed at the hot end of the recuperative heat exchanger 10. The exchanger 11 allows achieving the necessary temperature therein, due to—the energy obtained by burning the pyrolysis gases, or—the energy of the exhaust gases of the engine 6,—or electric energy from any suitable source,—or otherwise provided energy.

The volume of the secondary circuit of heat exchanger 11 and the flow rate of recycled waste are calculated so as to provide a sufficient time (typically 0.1-10 min) of waste exposure to the high temperatures, because the speed of some thermochemical processes is determined by the monomolecular mechanism and practically depends only on the temperature of reagents.

In the case where obtaining solid products (such as carbon powder) is not required, the temperature in the heat exchanger 11, as a rule, should exceed 650 C. In these conditions, water itself becomes an active oxidant of organic substances, a reaction of solid carbon with water is effectively conducted as follows:

C+H2O=CO+H2.

This allows transferring the entire combustible condensed phase of organic waste into the gas phase. Noncombustible oxides and minerals are precipitated and collected in the ash collector 12.

After the pyrolysis is completed, the pyrolysis products accompanied by water flow into the opposite loop of the recuperative heat exchanger 10. At temperatures of pyrolysis products less than 370 C, when the liquid phase of water is formed, the light gases (H2, CO, CH4) can be freed from the liquid with the gas separator 13, and further drawn into the hydrocarbon synthesis reactor 5 for obtaining methyl and ethyl alcohol or the 92 gasoline, or immediately to the engine 6.

It is also possible to free the light gases from the liquid phase along with volatile liquids (ethyl and methyl alcohol, dimethyl ether, etc.) using the aforementioned vapor separator 15, after reducing the pressure to 10 MPa and below, using the pressure reduction unit 14 and reducing the temperature to 240 C and below. In this case there are also provided the conditions for a rectification method for extraction and separation of volatile liquids.

After passing through the thermochemical reactor 4, the water flow passes through the heat recovery unit 8 into the bunker 2; hydrocarbons are moved for processing into the synthesis reactor 5 or into the engine 6; solid ash, which may contain useful substances, is moved out from the ash collector 12 for recycling or disposal.

### INDUSTRIAL APPLICABILITY

Let's consider some examples of specific applications of the invention.

### Example 1

The waste is sawdust with a moisture of 50%. Suppose one needs to recycle 0.1 kg of sawdust per second (or 6 kg of sawdust per minute, or 360 kg of sawdust per hour or 8.64 tons of sawdust per day). Let's assume the pulp has a 90% moisture content.

Thusly:

1) Taking into account the calorific value of combustible mass of wood is about 20 MJ/kg, and provided that all the energy of wood will be converted into the heat energy, the total thermal power of the power-conversion installation is:

Wt=0.1 (kg/s)×0.5×20 (MJ/kg)=1 MW of thermal power.

2) Thermal energy of the fuel mass will be largely realized in the form of combustion energy derived from the pyrolysis of combustible gases. With the assumption that the efficiency of converting the thermal energy into electric energy equals to 0.2, the generated electric power is:

We=0.2×Wt=0.2 MW.

3) When the wood ash content is equal to 0.5% of the fuel mass, the formation of ash will occur at a rate of:

Ash=0.1 (kg/s)×0.5×0.005=0.00025 (kg/s), or 21.6 kg/day.

Let's estimate the energy costs of creating a flow of pulp with a pressure of P=30 MPa. So, the volume of pulp necessary to pump is:

Qp=0.1 (kg/s)×(0.5+4.5)=0.5 (kg/s)=0.5 (l/s)=0.0005 (m3/s).

The power needed to apply to the pump is:

Wp=Qp×P=30×1,000,000×0.0005 (W)=15 kW.

Suppose, the efficiency of pump is 0.5 (it's usually higher) the pumping power will be:

15/0.5=30 kW.

If the flow of pyrolysis products is passed through expansion refrigerator, then, given that the expenditure volume rate of the gas pyrolysis products is much larger than the expenditure volume rate of the pulp, the pumping power for the pulp will be significantly less.

Thus, the energy consumed by pyrolysis under a high pressure in the flow of water does not exceed 15% of the electric energy generated, or constitutes no more than 3% of the heat energy obtained from the combustion of wood waste.

As for the effectiveness of obtaining volatile combustible gases for the inventive method of pyrolysis, it is well known from numerous experiments (see the above reference—“Biomass wood and Bioenergy. Monograph”) that an elevated pressure and an increased concentration of water vapor lead to an improved production of useful products of pyrolysis.

### Example 2

Processing 100 tons of poultry manure per day with a humidity of 95%.

Making calculations similar to the ones in Example 1, with a calorific value of combustible mass of manure being 20 MJ/kg, taking the amount of minerals in the manure of 5% by dry weight, one gets:

Thermal power:

Wt=100000×20×0.05/(24×3600)=1.16 MW;

Electric power (with efficiency=0.2):

We=0.2×WT=232 kW;

Power for pumping the manure at a pressure of 30 MPa:

Wp=0.5×30 (MPa)×100 (m3/day)/(24×3600)=17.4 kW;

Production of ashes (mineral fertilizer):

W=100000 (kg/day)×0.05×0.05=250 kg/day.

Example 2 shows the efficiency of obtaining energy, fuel, and fertilizer from poultry manure having a moisture content of 95%.

These examples show the effectiveness of the proposed method of processing organic waste to produce heat and electricity, as well as useful chemical products.

1. A method for processing and recycling organic waste; the method employs at least: a thermochemical reactor providing a pyrolysis processing of said organic waste through air-free thermal heating carried out in an aqueous medium, the pyrolysis processing is characterized with a predetermined operating temperature range; a power-conversion installation with a combustion chamber; and/or an installation for chemical conversion of pyrolysis products into synthetic fuels; wherein said method comprises the steps of:
(a) grinding the waste thereby forming a ground waste mass;
(b) adding water into the ground waste mass thereby forming a mixture;
(c) agitating the mixture thereby forming pulp, so that a concentration of water in said pulp is kept within a range of 30-99%;
(d) feeding the pulp into the thermochemical reactor, so that a pressure of the pulp is kept greater than the pressure of saturated water vapor over the entire said predetermined operating temperature range;
(e) heating the pulp in the thermochemical reactor up to a predetermined temperature at which the pyrolysis processing takes place, thereby forming pyrolysis products that include: a solid fraction, a gaseous fraction, and a liquid fraction including at least water and predetermined substances, wherein each said fraction has a corresponding pressure;
(f) extracting the solid fraction from the pulp;
(g) cooling the liquid and gaseous fractions;
(h) reducing the pressure of said liquid and gaseous fractions by at least performing a mechanical work;
(i) separating the gaseous fraction from the liquid fraction;
(j) transferring the gaseous fraction into the combustion chamber, and/or into the installation for chemical conversion of pyrolysis products into synthetic fuels;
(k) extracting the predetermined substances from the liquid fraction, causing the liquid fraction to substantially include water; and
(l) returning the so obtained water of said liquid fraction into the ground waste mass, according to the step (b).

2. The method according to claim 1, characterized in that the pressure of the pulp in said thermochemical reactor is established within the range of 22.0-40.0 MPa, a maximum temperature in the thermochemical reactor is set in the range of 350-900 C, and said pulp is exposed to the pressure and the temperature within said corresponding ranges during a time period in the range of 0.1-10 minutes.

3. The method according to claim 1, characterized in that
said heating of the pulp and said cooling of the liquid fraction are carried out by heat exchange between a flow of said pulp and a flow of said liquid fraction arranged in a recuperative heat exchanger having a predetermined hot part, wherein the flow of said liquid fraction and the flow of said pulp move in opposite directions, and additional heat energy is induced into the flow of pulp within an additional heat exchanger connected to the predetermined hot part.

4. The method according to claim 1, wherein said pyrolysis products include at least one of the following non-condensable gases: H2, CO, and CH4; said pyrolysis products include at least one of the following volatile liquids: ethanol, methanol, dimethyl, and ether; and said method is characterized in that
said at least one non-condensable gas is extracted from the pyrolysis products contained in a flow of said pulp at a temperature below 370 C, regardless of pressure; and
said at least one volatile liquid is extracted from the pyrolysis products contained in a flow of said pulp at a temperature below 240 C, at a pressure below 10 MPa, and at a condition when a predetermined substantial portion of water is in the condensed state, while reducing the pressure of said gaseous fraction by throttling or by completion of mechanical work.

5. The method according to claim 1, wherein sodium hydroxide or/and sodium sulfate are added into said mixture at the step (b).

6. A device for processing and recycling organic waste according to the method of claim 1, said device comprising:
a grinder of waste;
a thermochemical reactor for pyrolysis of said waste;
a power-conversion installation essentially associated with said thermochemical reactor;
a reactor for synthesis of fuels from pyrolysis gases, essentially associated with said thermochemical reactor; said reactor for synthesis of fuels is capable of separating the fuels;
a bunker receiving said ground waste mass from said grinder, said bunker is capable of preparing the pulp from said mixture;
a means for pumping the pulp to create pressure in a flow of said pulp passing through the thermochemical reactor, said means for pumping is connected with—said bunker receiving the pulp therefrom, and with—said thermochemical reactor pumping the pulp thereto;
an ash collector for receiving and removing components of the solid fraction from said pulp; and
a gas separator for separating the gaseous fraction from the liquid fraction.

7. The device according to claim 6,
wherein said device further comprises:
a recuperative heat exchanger of the spiral type, said recuperative heat exchanger receives the flow of said pulp from said means for pumping; and
an additional heat exchanger heating the pulp from an external heat source, said additional heat exchanger receives the flow of said pulp from said recuperative heat exchanger;
wherein said additional heat exchanger is equipped with an outlet of the pulp, and said ash collector is mounted at the outlet receiving said components of the solid fraction.

8. The device according to claim 6, wherein:
said device further comprises an expansion refrigerator;
the thermochemical reactor further includes a pyrolysis zone wherein said pyrolysis processing takes place, and an output of said pyrolysis products therefrom; and
wherein said expansion refrigerator is mounted at said output.

9. The device according to claim 6, wherein
said power-conversion installation further comprises: an engine operatively producing exhaust gases; an electric generator; and a unit for utilization of heat of the exhaust gases;
wherein said engine is represented by one of the following: an internal combustion engine, a diesel engine, a gas turbine engine, a steam engine, and a Stirling engine.
